(19) United States
(12) Patent Application Publication
(10) Pub. No.: US 2012/0069557 A1
(43) Pub. Date: Mar. 22, 2012

(54) ELONGATED LUMINAIRE AND A METHOD OF ATTACHING A LUMINAIRE TO A SURFACE

(75) Inventor: Rick Bolscher, Shanghai (CN)

(73) Assignee: KONINKLIJKE PHILIPS ELECTRONICS N.V., Eindhoven (NL)

(21) Appl. No.: 13/321,888

(22) PCT Filed: May 20, 2010
(86) PCT No.: PCT/IB2010/052238

§ 371 Date: Nov. 22, 2011

(30) Foreign Application Priority Data
May 27, 2009 (EP) 09161246.5

(51) Int. Cl. F21V 21/00

(52) U.S. Cl. 362/217.16

(57) ABSTRACT

An elongated luminaire and a method of attaching a luminaire to a mounting surface. The luminaire comprises at least two fixation members (1,2). Each fixation member (1,2) has a contact surface for abutting against said mounting surface, which contact surface has an opening (8) for receiving a fastener for attaching the fixation member (1,2) firmly to said mounting surface. The contact surfaces are provided with a layer of adhesive material (15) for temporarily attaching the luminaire (4) to the mounting surface.

### FIELD OF THE INVENTION

The invention is related to an elongated luminaire comprising at least two fixation members for attaching the luminaire to a mounting surface, which fixation members are located at a distance from each other, and each fixation member has a contact surface for abutting against said mounting surface, which contact surface has an opening for receiving a fastener for attaching the fixation member firmly to said mounting surface.

The mounting surface can be a wall or a ceiling or any other surface, for example the curved surface of a pipe or bar. One or more of such luminaires can be used to illuminate a room or an office or a corridor, or any other space inside or outside a building. The luminaires can be fixedly arranged in an array (in line), such that the ends of subsequent luminaires abut each other. In such an arrangement, a fixation member may engage both abutting ends of two luminaires. In such a fixation method the luminaire is also regarded as comprising two fixation members, i.e. one fixation member at each end. The luminaire is provided with one or more lamps, for example elongated gas discharge lamps, and may have a length of about 1.5 meters.

A luminaire as described above is disclosed in EP-A-1267119. This publication describes a luminaire to be mounted against a mounting surface, being a wall or a ceiling. The luminaire comprises two fixation members at its backside in order to fix the luminaire to the mounting surface by means of fasteners such as screws or the like. The two fixation members are detachably connected with the remainder part of the luminaire, so that the two fixation members can separately be fixed to the mounting surface by means of the fasteners. After the two fixation members are mounted, the luminaire can be attached to the fixation members by means of a snap-connection, whereby the luminaire can be fixed in a first position at some distance from the mounting surface, so that the backside of the luminaire is accessible for making the required electric connection for current supply to the luminaire. A snap-connection is a connection where the fixation is caused by the elastic force of one of the components to be connected. After the electric wires are connected at the backside of the luminaire, the luminaire can be fixed to the fixation members, thus assuming its final position against the mounting surface or close to the mounting surface.

The luminaire may be directly connected with the fixation members, but in another embodiment the luminaire is connected with the fixation members through a cord, so that the luminaire is suspended at a distance from the fixation members.

### BACKGROUND OF THE INVENTION

In order to fix the elongated luminaire to the mounting surface, the fixation members have to be fixed to the mounting surface. Therefore, the location of the fasteners for fixing the fixation members has to be marked on the mounting surface, so that holes can be drilled in the mounting surface. In this respect, it is required that the exact locations of the fixation members with respect to the luminaire, in particular the distance between the two fixation members, should be known or should be measured. As an alternative, the location of the fasteners can be marked on the mounting surface while a second person keeps the luminaire in the desired position against the mounting surface.

In order to define the correct position of each luminaire, it may be necessary to keep the fixation members against the mounting surface for a moment, so that the position of the luminaire can be inspected, preferably by a second person at a distance from the luminaire.

### SUMMARY OF THE INVENTION

It is an object of the invention to provide an elongated luminaire that is to be attached to a mounting surface by means of fasteners, wherein one person can fix the luminaire to the mounting surface in a relatively easy manner.

Another object of the invention is to provide an elongated luminaire that is to be attached to a mounting surface by means of fasteners, wherein the position of the fasteners can be checked or marked on the mounting surface in a relatively easy manner.

Yet another object of the invention is to provide an elongated luminaire that is to be attached to a mounting surface by means of fasteners, wherein the fixation members of the luminaire can easily be held against the mounting surface at the correct location for some time.

Another object of the invention is to provide an elongated luminaire that is to be attached to a mounting surface by means of fasteners, wherein the luminaire can be temporarily attached to the mounting surface before the final fixation takes place.

In order to achieve one or more of these objects, said contact surface of each fixation member is provided with a layer of adhesive material, so that the fixation members can be attached to the mounting surface by means of said layer of adhesive material. In a preferred embodiment, the layer of adhesive material is covered by a detachable cover layer, which cover layer protects the layer of adhesive material until the cover layer is peeled off in order to attach the fixation member to the mounting surface.

The fixation members can be attached by means of the layer of adhesive material while the fixation members are connected to the remainder part of the luminaire, thus enabling the position of the luminaire on the mounting surface to be inspected, so that incorrect positioning is avoided. The further operation performed to fix the fixation members by means of fasteners can be performed in a number of alternative ways.

In a first alternative way, the luminaire is temporarily fixed by means of the layer of adhesive material, wherein the location of the fasteners is marked on the mounting surface. Such an operation can easily be performed by one person, because there is no need to hold the luminaire when marking the fastener locations. Subsequently, the luminaire including the fixation members can be taken away from the mounting surface, and the holes in the mounting surface for receiving the fasteners can be drilled. Next, the luminaire can be firmly fixed to the mounting surface by means of the fasteners in the usual manner.

In a second alternative way, the luminaire is fixed by means of the layer of adhesive material, whereafter the luminaire is hinged away with respect to the fixation members. Therefore, in a preferred embodiment of the luminaire, the fixation members can hinge with respect to the remainder part of the luminaire, enabling the latter to be moved away from the fixation members to a position where the holes for the fasteners in the mounting surface can be drilled. Thus, the holes can be drilled and the fasteners can be installed when the luminaire is hinged away, after which the luminaire is hinged back to its final position.

In a third alternative way, the luminaire is fixed by means of the layer of adhesive material, after which the luminaire is taken away, while the fixation members remain in the required position against the mounting surface. Therefore, in a preferred embodiment of the luminaire, the fixation members are detachably connected with the remainder part of the luminaire. After the fixation members are firmly fixed by means of fasteners, the luminaire can be replaced in its final position, held by the fixation members.

The luminaire is preferably fixed to the fixation members by means of a snap-connection, for example as shown in EP-A-1267119.

In a preferred embodiment, the luminaire comprises one or more straight elongated gas discharge lamps. Such lamps are appropriate for lighting a large space, such as an office or a corridor.

The invention is also related to a method of attaching an elongated luminaire to a mounting surface, in which the luminaire comprises at least two fixation members at a distance from each other, and each fixation member has a contact surface for abutting against said mounting surface, which fixation members are fixed to said mounting surface by means of fasteners, and wherein said contact surface of each fixation member is provided with a layer of adhesive material before the fixation member is attached to said mounting surface, and wherein the fixation member is attached to said mounting surface by means of said layer of adhesive material before it is fixed to said mounting surface by means of said fasteners.

The layer of adhesive material can be applied by a person who is involved in the process of mounting the luminaire against the mounting surface. However, in a preferred embodiment of the invention, the layer of adhesive material is applied during the manufacturing process of the luminaire.

### BRIEF DESCRIPTION OF THE DRAWING

The invention will now be further elucidated by means of a description of an embodiment of an elongated luminaire, wherein reference is made to the drawing, in which:

FIG. 1 is a perspective view of the luminaire;

FIG. 2 shows the fixation member in a perspective view;

FIG. 3 is a sectional view of the luminaire; and

FIG. 4 is another sectional view of the luminaire.

### DETAILED DESCRIPTION OF EMBODIMENTS

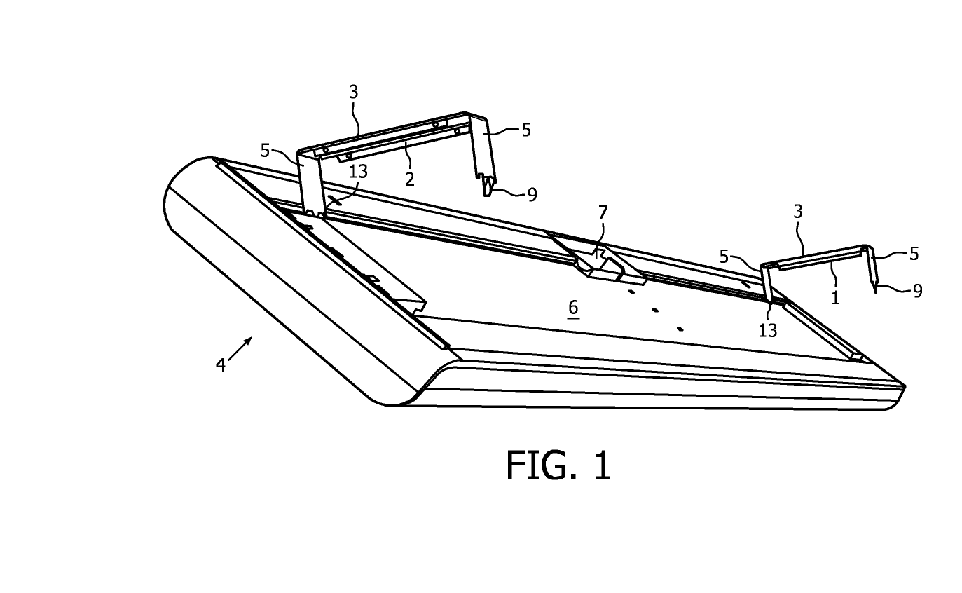

FIG. 1 shows an elongated luminaire comprising two U-shaped fixation members 1,2. The base part 3 of each fixation member abuts against a horizontal ceiling (not shown in the Figure), and the remainder part 4 of the luminaire is connected with one of the legs 5 of each U-shaped fixation member 1,2. The luminaire 4 can hinge with respect to the two fixation members 1,2 between the inclined position as shown in FIG. 1 and a horizontal position in which the luminaire 4 is connected with both legs 5 of each fixation member 1,2. The final position of the luminaire 4 is said horizontal position, in which position the luminaire 4 is located close to the ceiling and the two legs 5 of each fixation member 1,2 project into the luminaire 4.

The backside 6 of the luminaire is provided with a chamber 7 for accommodating the electric connection wires for supplying current to the luminaire 4. FIG. 1 shows the position of the luminaire 4 in which the chamber 7 is accessible for making the required electric connections. After the luminaire 4 is positioned close to the ceiling, the chamber 7 is not accessible anymore.

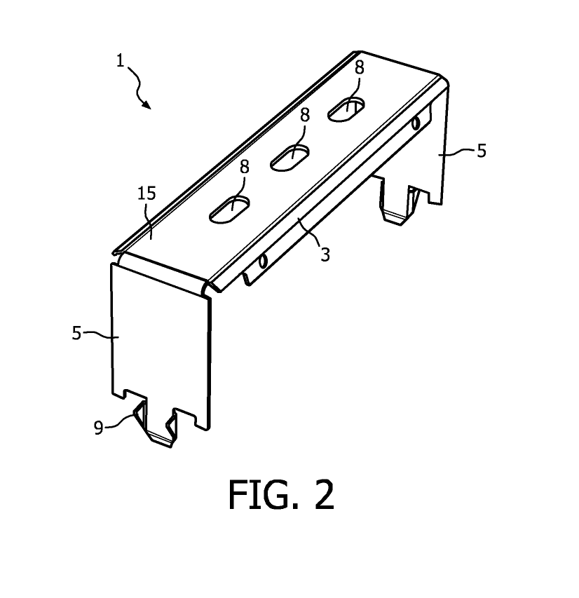

FIG. 2 shows the fixation member 1 in more detail. The base part 3 comprises three openings 8 for accommodating screws for firmly fixing the fixation member 1 to the mounting surface, such as a ceiling or a wall. Each of the two legs 5 is provided with an engagement member 9 that can engage with a corresponding part in the luminaire 4, so that the luminaire 4 is detachably held by the fixation member 1. The flat surface of base part 3 is provided with a layer of adhesive material 15 in order to attach the fixation members 1,2 to a mounting surface before the fixation members 1,2 are firmly fixed to the mounting surface by means of fasteners reaching through openings 8.

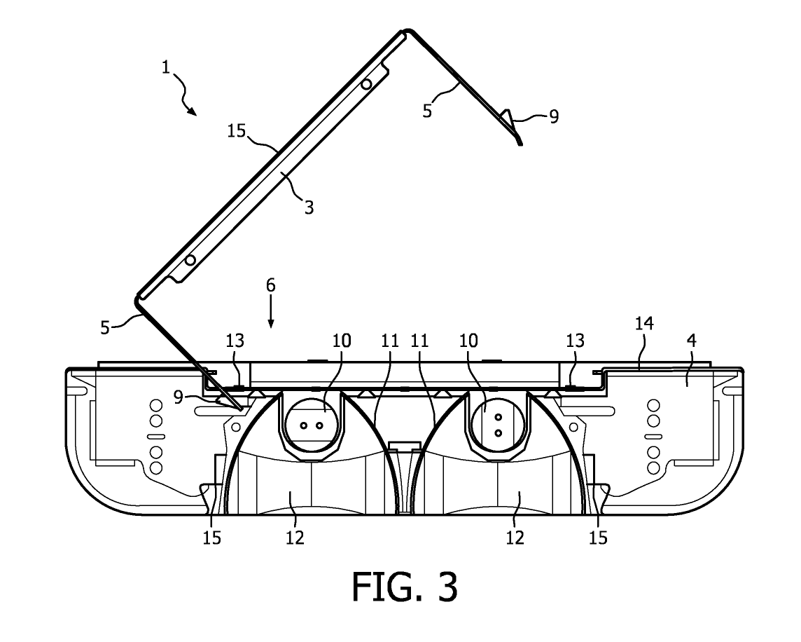

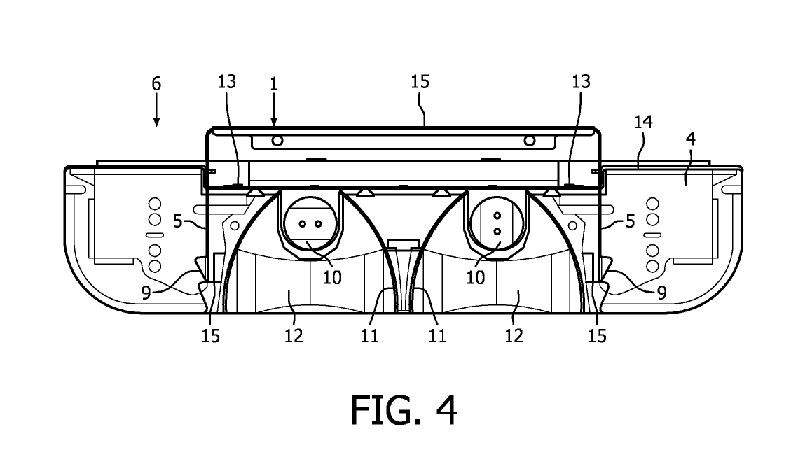

FIGS. 3 and 4 are cross sectional views of the elongated luminaire, showing more details than required for elucidating and understanding the invention. Therefore, not all parts of the shown luminaire will be described.

FIG. 3 shows the luminaire in the position as shown in FIG. 1, where the fixation member 1 is in an inclined position with respect to the remainder part 4 of the luminaire. The luminaire 4 comprises two elongated cylindrical lamps 10, each partly surrounded by a reflector 11. In front of each lamp 10 is a louver 12 for avoiding light radiation in undesired directions. At the backside 6 of the luminaire 4, openings 13 are provided in the housing 14 of the luminaire 4, through which openings 13 the legs 5 of the fixation members 1,2 can enter.

In the position of the luminaire as shown in FIGS. 1 and 3, only one leg 5 of fixation member 1, 2 extends through the opening 13. As a result, the engagement member 9 engages behind an edge of the opening 13, so that the luminaire 4 can suspend from the fixation members 1,2 when the fixation members 1,2 are attached to a ceiling, as is shown in FIG. 1. The luminaire 4 can be placed in its final position by moving the luminaire 4 and the fixation members 1,2 towards each other, whereby the legs 5 of the two fixation members 1,2 move into the housing 14 of the luminaire 4, as is shown in FIG. 4. In the final position, the engagement members 9 of the fixation members 1,2 engage behind support members 15 in the housing 14. This final position will be reached when the luminaire 4 is moved further upwards form the position that is represented in FIG. 4.

While the invention has been illustrated in the drawings and the foregoing description, such illustration and description are to be considered illustrative or exemplary and not restrictive; the invention is not limited to the disclosed embodiment. Any reference signs in the claims should not be construed as limiting the scope of the invention.

1. A luminaire comprising at least two fixation members for attaching the luminaire to a mounting surface, the fixation members being located at a distance from each other, and each fixation member having a contact surface for abutting against said mounting surface, wherein said contact surface comprises a layer of adhesive material disposed thereon and defines an opening for receiving a fastener for attaching the fixation member to said mounting surface.

2. A luminaire as claimed in claim 1, wherein the layer of adhesive material is covered with a detachable cover layer.

3. A luminaire as claimed in claim 1, wherein the fixation members are hingedly rotatable relative to the luminaire.

4. A luminaire as claimed in claim 1, wherein the fixation members are detachably connected to the luminaire.

5. A luminaire as claimed in claim 1, further comprising one or more straight elongated gas discharge lamps.

6-7. (canceled)
